(19) United States
(12) Patent Application Publication
(10) Pub. No.: US 2026/0286107 A1
(43) Pub. Date: Sep. 24, 2026

(54) RUBBER COMPOSITIONS AND ARTICLES THEREOF

(71) Applicant: The Goodyear Tire & Rubber Company, Akron, OH (US)

(72) Inventors: Ryan Michael Schmidt, Wadsworth, OH (US); Teresa Diane Martter, Akron, OH (US); Eric Engeldinger, Redange-sur-Attert (LU)

(21) Appl. No.: 19/082,256

(22) Filed: Mar. 18, 2025

(51) Int. Cl. C08L 15/00; B60C 1/00

(52) U.S. Cl. CPC C08L 15/00; B60C 1/00; C08L 2205/025; C08L 2205/035; C08L 2207/322; C08L 2312/02

(57) ABSTRACT

In accordance with the purpose(s) of the present disclosure, as embodied and broadly described herein, are vulcanized rubber compositions with improved physical properties such as, for example, stiffness and hysteresis. In one aspect, an uncured composition is described herein wherein the composition comprises (1) at least one partially saturated elastomer comprising repeat units, wherein less than or equal to 15% of all repeat units of the partially saturated elastomer comprise a double bond, (2) a bismaleimide, and (3) a polyoctenamer. The uncured rubber compositions can be vulcanized to produce a variety of components used in the production of tires.

### BACKGROUND

The demand for improved tire performance has resulted in the development and evaluation of new materials that have desired properties. In tire elastomer compositions, improving one property of the composition usually comes at the cost of reducing the performance in other areas. There is a need for elastomer compositions for tires that can provide improvement in properties such as stiffness and hysteresis while maintaining acceptable performance in other properties.

### SUMMARY

In accordance with the purpose(s) of the present disclosure, as embodied and broadly described herein, are vulcanized rubber compositions with improved physical properties such as, for example, stiffness and hysteresis. In one aspect, an uncured composition is described herein wherein the composition comprises (1) at least one partially saturated elastomer comprising repeat units, wherein less than or equal to 15% of all repeat units of the partially saturated elastomer comprise a double bond, (2) a bismaleimide, and (3) a polyoctenamer. The uncured rubber compositions can be vulcanized to produce a variety of components used in the production of tires.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims. In addition, all optional and preferred features and modifications of the described embodiments are usable in all aspects of the disclosure taught herein. Furthermore, the individual features of the dependent claims, as well as all optional and preferred features and modifications of the described embodiments are combinable and interchangeable with one another.

### DETAILED DESCRIPTION

Many modifications and other embodiments disclosed herein will come to mind to one skilled in the art to which the disclosed compositions and methods pertain having the benefit of the teachings presented in the foregoing descriptions and the associated drawings. Therefore, it is to be understood that the disclosures are not to be limited to the specific embodiments disclosed and that modifications and other embodiments are intended to be included within the scope of the appended claims. The skilled artisan will recognize many variants and adaptations of the aspects described herein. These variants and adaptations are intended to be included in the teachings of this disclosure and to be encompassed by the claims herein.

Although specific terms are employed herein, they are used in a generic and descriptive sense only and not for purposes of limitation.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure.

Any recited method can be carried out in the order of events recited or in any other order that is logically possible. That is, unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is no way intended that an order be inferred, in any respect. This holds for any possible non-express basis for interpretation, including matters of logic with respect to arrangement of steps or operational flow, plain meaning derived from grammatical organization or punctuation, or the number or type of aspects described in the specification.

All publications mentioned herein are incorporated herein by reference to disclose and describe the methods and/or materials in connection with which the publications are cited. The publications discussed herein are provided solely for their disclosure prior to the filing date of the present application. Nothing herein is to be construed as an admission that the present invention is not entitled to antedate such publication by virtue of prior invention. Further, the dates of publication provided herein can be different from the actual publication dates, which can require independent confirmation.

While aspects of the present disclosure can be described and claimed in a particular statutory class, such as the system statutory class, this is for convenience only and one of skill in the art will understand that each aspect of the present disclosure can be described and claimed in any statutory class.

It is also to be understood that the terminology used herein is for the purpose of describing particular aspects only and is not intended to be limiting. Unless defined otherwise, all technical and scientific terms used herein have the same meaning as commonly understood by one of ordinary skill in the art to which the disclosed compositions and methods belong. It will be further understood that terms, such as those defined in commonly used dictionaries, should be interpreted as having a meaning that is consistent with their meaning in the context of the specification and relevant art and should not be interpreted in an idealized or overly formal sense unless expressly defined herein.

Prior to describing the various aspects of the present disclosure, the following definitions are provided and should be used unless otherwise indicated. Additional terms may be defined elsewhere in the present disclosure.

### Definitions

As used herein, “comprising” is to be interpreted as specifying the presence of the stated features, integers, steps, or components as referred to, but does not preclude the presence or addition of one or more features, integers, steps, or components, or groups thereof. Moreover, each of the terms “by”, “comprising,” “comprises”, “comprised of,” “including,” “includes,” “included,” “involving,” “involves,” “involved,” and “such as” are used in their open, non-limiting sense and may be used interchangeably. Further, the term “comprising” is intended to include examples and aspects encompassed by the terms “consisting essentially of” and “consisting of.” Similarly, the term “consisting essentially of” is intended to include examples encompassed by the term “consisting of.

As used in the specification and the appended claims, the singular forms “a,” “an,” and “the” include plural referents unless the context clearly dictates otherwise. Thus, for example, reference to “an elastomer” or “a vulcanizing agent,” include, but are not limited to, mixtures or combinations of two or more such elastomers or vulcanizing agents, and the like.

It should be noted that ratios, concentrations, amounts, and other numerical data can be expressed herein in a range format. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. Ranges can be expressed herein as from “about” one particular value, and/or to “about” another particular value. Similarly, when values are expressed as approximations, by use of the antecedent “about,” it will be understood that the particular value forms a further aspect. For example, if the value “about 10” is disclosed, then “10” is also disclosed.

When a range is expressed, a further aspect includes from the one particular value and/or to the other particular value. For example, where the stated range includes one or both of the limits, ranges excluding either or both of those included limits are also included in the disclosure, e.g. the phrase “x to y” includes the range from ‘x’ to ‘y’ as well as the range greater than ‘x’ and less than ‘y’. The range can also be expressed as an upper limit, e.g. ‘about x, y, z, or less’ and should be interpreted to include the specific ranges of ‘about x’, ‘about y’, and ‘about z’ as well as the ranges of ‘less than x’, less than y’, and ‘less than z’. Likewise, the phrase ‘about x, y, z, or greater’ should be interpreted to include the specific ranges of ‘about x’, ‘about y’, and ‘about z’ as well as the ranges of ‘greater than x’, greater than y’, and ‘greater than z’. In addition, the phrase “about ‘x’ to ‘y’”, where ‘x’ and ‘y’ are numerical values, includes “about ‘x’ to about ‘y’”.

It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a numerical range of “about 0.1% to 5%” should be interpreted to include not only the explicitly recited values of about 0.1% to about 5%, but also include individual values (e.g., about 1%, about 2%, about 3%, and about 4%) and the sub-ranges (e.g., about 0.5% to about 1.1%; about 5% to about 2.4%; about 0.5% to about 3.2%, and about 0.5% to about 4.4%, and other possible sub-ranges) within the indicated range.

As used herein, the terms “about,” “approximate,” “at or about,” and “substantially” mean that the amount or value in question can be the exact value or a value that provides equivalent results or effects as recited in the claims or taught herein. That is, it is understood that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art such that equivalent results or effects are obtained. In some circumstances, the value that provides equivalent results or effects cannot be reasonably determined. In such cases, it is generally understood, as used herein, that “about” and “at or about” mean the nominal value indicated ±10% variation unless otherwise indicated or inferred. In general, an amount, size, formulation, parameter or other quantity or characteristic is “about,” “approximate,” or “at or about” whether or not expressly stated to be such. It is understood that where “about,” “approximate,” or “at or about” is used before a quantitative value, the parameter also includes the specific quantitative value itself, unless specifically stated otherwise.

As used herein, the terms “optional” or “optionally” means that the subsequently described event or circumstance can or cannot occur, and that the description includes instances where said event or circumstance occurs and instances where it does not.

As used herein, the term “phr” refers to parts by weight of a respective material per 100 parts by weight of rubber or elastomer. In general, using this convention, an elastomer composition is comprised of 100 parts by weight of rubber/elastomer. The claimed composition may comprise other rubbers/elastomers than explicitly mentioned in the claims, provided that the phr value of the claimed rubbers elastomers is in accordance with claimed phr ranges and the amount of all rubbers/elastomers in the composition results in total in 100 parts of rubber.

The terms “rubber” and “elastomer” may be used herein interchangeably, unless indicated otherwise.

As used herein, the “glass transition temperature” or “T_{g}”, of an elastomer or rubber represents the glass transition temperature(s) of the respective elastomer or rubber in its uncured state or, in the case of an elastomer composition, in some aspects, T_{g} can be measured in a cured state.

As used herein, the term “uncured composition” refers to a composition including at least one natural or synthetic rubber component and, optionally, one or more fillers, processing aids, or additional compounds, that has not been vulcanized. Uncured rubber is sensitive to changes in temperature and has a tendency to undergo “cold flow” (slow movement or deformation under stress) over time. In some aspects, the uncured rubber composition is a masterbatch.

As used herein, the term “vulcanized rubber composition” refers to a rubber composition obtained by taking an uncured composition as described herein and curing or vulcanizing it, often accomplished using sulfur compounds and/or other curing additives and in the presence of heat. Vulcanized or cured rubber does not undergo cold flow and is less sensitive to changes in temperature relative to uncured rubber. In another aspect, rubber compositions can be cured in molds in order to form finished articles including, but not limited to, tires.

As used herein, the term “repeat unit” as referenced in the partially saturated elastomers described herein are derived from monomers used to produce the partially saturated elastomers. For example, polybutadiene has the repeat unit as provided below, where the repeat unit can have cis or trans stereochemistry

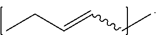

In certain aspects, when the partially saturated elastomer is the polymerization product of two different monomers (e.g., A and B), the repeat unit can be represented by -A-B-.

The term “aryl” as used herein is a group that contains any carbon-based aromatic group including, but not limited to, benzene, naphthalene, phenyl, biphenyl, anthracene, and the like. The aryl group can be substituted or unsubstituted. The aryl group can be substituted with one or more groups including, but not limited to, alkyl, cycloalkyl, alkoxy, alkenyl, cycloalkenyl, alkynyl, cycloalkynyl, aryl, heteroaryl, aldehyde, —NH₂, carboxylic acid, ester, ether, halide, hydroxy, ketone, azide, nitro, silyl, sulfo-oxo, or thiol as described herein. The term “biaryl” is a specific type of aryl group and is included in the definition of “aryl.” In addition, the aryl group can be a single ring structure or comprise multiple ring structures that are either fused ring structures or attached via one or more bridging groups such as a carbon-carbon bond. For example, biaryl to two aryl groups that are bound together via a fused ring structure, as in naphthalene, or are attached via one or more carbon-carbon bonds, as in biphenyl. Fused aryl groups including, but not limited to, indene and naphthalene groups are also contemplated.

Unless otherwise specified, pressures referred to herein are based on atmospheric pressure (i.e. one atmosphere).

### Rubber Compositions and Articles Thereof

The present disclosure provides for uncured rubber compositions, methods of making uncured rubber compositions, vulcanized rubber compositions, methods of making vulcanized rubber composition, articles (e.g., tires, components of tires) including the vulcanized rubber composition, and the like. The present disclosure provides for vulcanized rubber compositions that can be used in articles such as tires with improved physical properties while not compromising other properties of the composition.

It has been discovered that the use of a partially saturated elastomer results in the formation of rubber compositions with good physical properties. In one aspect, the partially saturated elastomer includes repeat units where less than or equal to 15% of all repeat units include a double bond. In other aspects, the amount of repeat units that include a double bond can be about 1%, 2%, 3%, 4%, 5%, 6%, 7%, 8%, 9%, 10%, 11%, 12%, 13%, 14%, or less than or equal to 15%, where any value can be a lower and upper endpoint of a range (e.g., 5% to 10%). When counting double bonds, the double bonds in an aromatic structure or group, such as those present in a styrene repeat unit, are not included in the count. However, a styrene unit is still counted as a repeat unit for the determination of the total number of repeat units in an elastomer.

In one aspect, the partially saturated elastomer can comprise repeat units formed by residues of monomers selected from one or more of ethylene, propylene, butadiene, isoprene, styrene, and any combination thereof. In further aspects, the partially saturated elastomer is a hydrogenated styrene butadiene rubber, in some aspects a hydrogenated solution-polymerized styrene butadiene rubber (SSBR). The hydrogenated styrene butadiene rubber can have a styrene content from about 5 wt % to about 40 wt %, or about 5 wt %, 10 wt %, 15 wt %, 20 wt %, 25 wt %, 30 wt %, 35 wt %, or 40 wt %, where any value can be a lower and upper endpoint of a range (e.g., 20 wt % to 40 wt %), and a butadiene content from about 60 wt % to about 95 wt %, or about 60 wt %, 65 wt %, 70 wt %, 75 wt %, 80 wt %, 85 wt %, 90 wt %, or 95 wt %, where any value can be a lower and upper endpoint of a range (e.g., 75 wt % to 90 wt %). In some aspects, an SSBR can be referred to as a partially hydrogenated SSBR (HSBR) when less than or equal to 15% of all repeat units of the SSBR include a double bond.

In other aspects, HSBR can be characterized as having about 1%, 2%, 3%, 4%, 5%, 6%, 7%, 8%, 9%, 10%, 11%, 12%, 13%, 14%, or less than or equal to 15%, where any value can be a lower and upper endpoint of a range (e.g., 4% to 11%), of all repeat units include a double bond. HSBR can also be characterized by having a weight average molecular weight (M_{w}) from about 100 kg/mol to about 4,000 kg/mol, or 100 kg/mol, 200 kg/mol, 300 kg/mol, 400 kg/mol, 500 kg/mol, 600 kg/mol, 700 kg/mol, 800 kg/mol, 900 kg/mol, 1,000 kg/mol, 1,100 kg/mol, 1,200 kg/mol, 1,300 kg/mol, 1,400 kg/mol, 1,500 kg/mol, 2,000 kg/mol, 3,000 kg/mol, or 4,000 kg/mol where any value can be a lower and upper endpoint of a range (e.g., 600 kg/mol to 900 kg/mol). In a further aspect, HSBR can be characterized by having a polydispersity index (M_{w}/Mₙ, Mₙ being the number average molecular weight) of about 1.05 to about 2.0 or 1.2, 1.4, 1.6, 1.8, or 2.0, where any value can be a lower and upper endpoint of a range (e.g., 1.4 to 1.8). Molecular weight parameters can be determined via gel permeation chromatography according to ASTM 5296-11 using polystyrene calibration standards, or an equivalent. In other aspects, HSBR can have a glass transition temperature from about −70° C. to about −20° C., or about −70° C., −60° C., −50° C., −40° C., −30° C., or −20° C., where any value can be a lower and upper endpoint of a range (e.g., −60° C. to −40° C.).

A partially saturated elastomer, in some aspects HSBR, can be obtained by hydrogenating an elastomer. A method for hydrogenating an elastomer can be performed by any methods known in the art. In one aspect, hydrogenation is performed by blowing aqueous hydrogen into an elastomer or polymer solution in the presence of a catalyst, such as a heterogeneous catalyst, a homogeneous catalyst, a catalyst using metallocene, such as titanocene, or any combination thereof. Examples of heterogenous catalysts include a catalyst containing a noble metal supported on a porous inorganic substance. Examples of homogenous catalysts include a catalyst obtained by reacting a solubilized salt of nickel, cobalt, or the like with organic aluminum or the like. The extent of hydrogenation in the resulting elastomer can be controlled by varying factors such as the amount of hydrogen added, the pressure of the hydrogen, the reaction time, the reaction temperature, the amount of catalyst added, the polymer solution viscosity, or any combination thereof. In some aspects, the hydrogenation reaction is carried out at a temperature of from about 60° C. to 105° C. or about 60° C., 70° C., 80° C., 90° C., 100° C., or 105° C., where any value can be a lower and upper endpoint of a range (e.g., 70° C. to 100° C.). In some aspects, the hydrogenation reaction is carried out as a batch process, a continuous process, or a combination thereof. Additional details regarding the production of partially saturated elastomers are described in United States Patent Application Publication US 2023/0138073 A1 and European Patent Application Publication EP 4261234 A1 and are incorporated herein by reference.

In one aspect, the uncured rubber composition includes about 75 phr to about 100 phr of the partially saturated elastomer, or about 75 phr, 80 phr, 85 phr, 90 phr, 95 phr, or 100 phr, where any value can be a lower and upper endpoint of a range (e.g., 80 phr to 90 phr).

In one aspect, the rubber composition includes
75 phr to 100 phr of the partially saturated elastomer, and
0 phr to 25 phr of one or more of polybutadiene rubber, polyisoprene, hydrogenated styrene butadiene rubber, and natural rubber.

In another aspect, the partially saturated elastomer comprises a solution-polymerized styrene butadiene rubber having one or more of:
i) less than 5% of nonhydrogenated vinyl groups, based on the total number of vinyl groups of a hydrogenated styrene butadiene rubber;
ii) less than 20% of nonhydrogenated double bonds in cis-1,4 and trans-1,4 butadiene repeat units, based on the total number of cis-1,4 and trans-1,4 butadiene repeat units;
iii) from 80% to 99% of hydrogenated double bonds; and
iv) a bound styrene content ranging from 5% to 40% and a butadiene content ranging from 60% to 95%, by weight.

The uncured compositions described herein include a bismaleimide. A bismaleimide is a compound possessing two maleimide groups. In one aspect, the bismaleimide is an aryl compound having two maleimide groups covalently bonded to the aryl group. In another aspect, the bismaleimide is N,N′-m-phenylenebismaleimide. In one aspect, the uncured rubber composition includes about 1 phr to about 10 phr of the bismaleimide, or about 1 phr, 2 phr, 3 phr, 4 phr, 5 phr, 6 phr, 7 phr, 8 phr, 9 phr, or 10 phr, where any value can be a lower and upper endpoint of a range (e.g., 2 phr to 5 phr).

In one aspect, the rubber composition includes from 5 phr to 20 phr of a polyoctenamer. In another aspect, the amount of polyoctenamer in the composition can be in the amount of about 5 phr, 7 phr, 9 phr, 11 phr, 13 phr, 15 phr, 17 phr, or 20 phr, where any value can be a lower and upper endpoint of a range (e.g., 7 phr to 17 phr).

In one aspect, the polyoctenamer has one or more of: a glass transition temperature within a range of −50° C. to −80° C., determined under ASTM D3418 as mentioned hereinbelow; a weight average molecular weight M_{w} within a range of 80,000 g/mol to 100,000 g/mol, determined by gel permeation chromatography (GPC) using polystyrene calibration standards according to ASTM 5296-11 or equivalent; and a melting point within a range of 45° C. to 55° C., measured by DSC in second heating, according to ASTM D3418 or equivalent. In another aspect, the polyoctenamer has between 65% and 85% of trans double bonds of all double bonds in the polyoctenamer.

The uncured rubber compositions described herein can include one or more additives typically used to produce rubber compositions.

In one aspect, the additive can be silica. In one aspect, the silica can be obtained by the acidification of a soluble silicate, e.g., sodium silicate. In one embodiment, the uncured composition includes about 85 to 95 phr or about 90 phr of the precipitated silica. Conventional silicas can be characterized by a Brunauer-Emmett-Teller (BET) surface area, as measured using nitrogen gas. In one aspect, the BET surface area can be in the range of about 150 m²/g to about 165 m²/g or about 160 m²/g. The BET method of measuring surface area is described in the Journal of the American Chemical Society, Volume 60, Page 304 (1930). In one embodiment, the conventional silica can have an average ultimate particle size in the range of about 0.01 μm to about 0.05 μm as determined by an electron microscope. In other embodiments, the silica particles are smaller than 0.01 μm. In other aspects, the silica particles are larger than 0.05 μm.

Exemplary untreated precipitated silicas are available from PPG Industries as Hi-SiI™ e.g., under the designations 210, 243, 315, EZ 160G-D, EZ 150G, 190G, 200G-D, HDP-320G, and 255CG-D; from Solvay as Zeosil™, under the designations 115GR, 125GR, 165GR, 175GR, 185GR, 195GR, 1085GR, 1165MP, 1115MP, HRS 1200MP, Premium MP, Premium 200MP, and 195HR; from Evonik as Ultrasil™, under the designations VN2, VN3, VN3GR, 5000GR, 7000GR, 9000GR, as Zeopol™, under the designations 8755LS and 8745; from Wuxi Quechen Silicon Chemical Co., Ltd. as Newsil™, underthe designations 115GR and 2000MP; from Maruo Calcium Co., Ltd., as Tokusil™ 315, and silicas derived from rice husk ash from Yihai Food and Oil Industry, China. Any precipitated silica can be used in the method. In other embodiments, the untreated precipitated silica is prepared as a wet filtered material shortly before use.

In another aspect, the silica may be pre-hydrophobated (or pre-silanized) precipitated silica. By pre-hydrophobated, it is meant that the silica is pretreated, i.e., the pre-hydrophobated precipitated silica is hydrophobated prior to its addition to the rubber composition by treatment with at least one silane. Suitable silanes include but are not limited to alkylsilanes, alkoxysilanes, organoalkoxysilyl polysulfides and organomercaptoalkoxysilanes. In an alternative embodiment, the pre-hydrophobated precipitated silica may be pre-treated with a silica coupling agent comprised of, for example, an alkoxyorganomercaptoalkoxysilane or combination of alkoxysilane and organomercaptoalkoxysilane prior to blending the pre-treated silica with the rubber instead of reacting the precipitated silica with the silica coupling agent in situ within the rubber. For example, see U.S. Pat. No. 7,214,731. The pre-hydrophobated precipitated silica may optionally be treated with a silica dispersing aid. Such silica dispersing aids may include glycols such as fatty acids, diethylene glycols, polyethylene glycols, fatty acid esters of hydrogenated or non-hydrogenated C5 or C6 sugars, and polyoxyethylene derivatives of fatty acid esters of hydrogenated or non-hydrogenated C5 or C6 sugars. Exemplary fatty acids include stearic acid, palmitic acid and oleic acid. Exemplary fatty acid esters of hydrogenated and non-hydrogenated C5 and C6 sugars (e.g., sorbose, mannose, and arabinose) include, but are not limited to, the sorbitan oleates, such as sorbitan monooleate, dioleate, trioleate and sesquioleate, as well as sorbitan esters of laurate, palmitate and stearate fatty acids. Exemplary polyoxyethylene derivatives of fatty acid esters of hydrogenated and non-hydrogenated C5 and C6 sugars include, but are not limited to, polysorbates and polyoxyethylene sorbitan esters, which are analogous to the fatty acid esters of hydrogenated and non-hydrogenated sugars noted above except that ethylene oxide groups are placed on each of the hydroxyl groups. Optional silica dispersing aids if used are present in an amount ranging from about 0.1% to about 25% by weight based on the weight of the silica, with about 0.5% to about 20% by weight being suitable, and about 1% to about 15% by weight based on the weight of the silica also being suitable. For various pre-treated precipitated silicas see, for example, U.S. Pat. Nos. 4,704,414, 6,123,762, and 6,573,324.

In one aspect, the additive is a plasticizer. In one aspect, the plasticizer is a hydrocarbon resin having a T_{g} greater than 30° C., preferably greater than 50° C., and more preferably greater than 60° C. and less than 100° C., such as hydrocarbon resins described in “Hydrocarbon Resins” by R. Mildenberger, M. Zander and G. Collin (New York, VCH, 1997, ISBN-3-527-28617-9). Representative hydrocarbon resins include for instance coumarone-indene-resins, petroleum resins, terpene resins, alphamethyl styrene resins and mixtures thereof.

Coumarone-indene resins are commercially available in many forms with melting points ranging from 10° C. to 160° C., preferably from 30° C. to 100° C. as measured by the ball-and-ring method). Coumarone-indene resins as such are well known. Various analysis indicate that such resins are largely polyindene; however, typically contain random polymeric units derived from methyl indene, coumarone, methyl coumarone, styrene and methyl styrene.

Petroleum resins are commercially available with softening points ranging from 10° C. to 120° C., preferably from 30° C. to 100° C. Suitable petroleum resins include both aromatic and nonaromatic types. Several types of petroleum resins are available. Some resins have a low degree of unsaturation and high aromatic content, whereas some are highly unsaturated and yet some contain no aromatic structure at all. Differences in the resins are largely due to the olefins in the feedstock from which the resins are derived. Conventional derivatives in such resins include dicyclopentadiene, cyclopentadiene, their dimers and diolefins such as isoprene and piperylene. In one aspect, the hydrocarbon resin is Oppera™ PR383 manufactured by Exxon Mobil, which is a hydrogenated C9 modified dicyclopentadiene having a T_{g} of about 54° C.

In one aspect, terpene resins can be used as the hydrocarbon resin. Terpene polymers (or resins) may be typically commercially produced from polymerizing alpha or beta pinenes. In particular, alpha pinene based resins may be used. Terpene resins may be supplied in a variety of melting points ranging from 10° C. to 135° C. The terpene resins may for example have a molecular weight M_{w} of less than 1000 g/mol, preferably less than 950 g/mol or ranging between 200 g/mol and 950 g/mol, as measured by gel permeation chromatography (GPC). An example of an alpha pinene based resin is Dercolyte™ A 115 of the company DRT which has a molecular weight M_{w} of about 900 g/mol.

In one aspect, the hydrocarbon resin is derived from styrene and alphamethylstyrene. The presence of the styrene/alphamethylstyrene resin with a rubber blend which contains the presence of the styrene-butadiene elastomer is considered herein to be beneficial because of observed viscoelastic properties of the tread rubber composition such as complex and storage modulus, loss modulus, tangent delta and loss compliance at different temperature/frequency/strain. The properties of complex and storage modulus, loss modulus, tangent delta and loss compliance are understood to be generally well known to those having skill in such art. The molecular weight distribution of the resin is visualized as a ratio of the resin's molecular weight average (Mw) to molecular weight number average (Mn) values and is considered herein to be in a range of about 1.5/1 to about 2.5/1 which is considered to be a relatively narrow range. This is believed to be advantageous because of the selective compatibility with the polymer matrix and because of a contemplated use of the tire in wet and dry conditions over a wide temperature range. The glass transition temperature Tg of the copolymer resin is considered herein to be in a range of about 20° C. to about 100° C., alternatively about 50° C. to about 70° C. A suitable measurement of T_{g} for resins is DSC according to ASTM D6604 or equivalent. The styrene/alphamethylstyrene resin is considered herein to be a copolymer of styrene and alphamethylstyrene with a styrene/alphamethylstyrene molar ratio in a range of about 0.40 to about 1.50. In one aspect, such a resin can be suitably prepared, for example, by cationic copolymerization of styrene and alphamethylstyrene in a hydrocarbon solvent. Thus, the contemplated styrene/alphamethylstyrene resin can be characterized, for example, by its chemical structure, namely, its styrene and alphamethylstyrene contents and softening point and also, if desired, by its glass transition temperature, molecular weight and molecular weight distribution. In one embodiment, the styrene/alphamethylstyrene resin is composed of about 40 to about 70 percent units derived from styrene and, correspondingly, about 60 to about 30 percent units derived from alphamethylstyrene. In one embodiment, the styrene/alphamethylstyrene resin has a softening point according to ASTM No. E-28 in a range of about 80° C. to about 145° C. Suitable styrene/alphamethylstyrene resin is available commercially as Resin 2336 from Eastman or Sylvares SA85 from Arizona Chemical.

In one aspect, the additive is a sulfur donor. Representative examples of sulfur donors include elemental sulfur (free sulfur), an amine disulfide, polymeric polysulfide and sulfur olefin adducts. In one aspect, the sulfur-vulcanizing agent is elemental sulfur. The sulfur donor may for instance be used in an amount ranging from 0.5 phr to 8 phr, alternatively with a range of from 1 phr to 3 phr.

In one aspect, the additive is an antioxidant (also referred to as an antidegradant). Representative antioxidants may be, for example, diphenyl-p-phenylenediamine and others, such as, for example, those disclosed in The Vanderbilt Rubber Handbook (1978), Pages 344 through 346. Typical amounts of antioxidants, if used, may for example include 1 phr to 5 phr.

In one aspect, the additive is an antiozonant. Representative antiozonants include, but are not limited to, N-phenyl-N′-(1,3-dimethylbutyl)-p-phenylenediamine (6PPD) and N,N′-o-tolyl-p-phenylenediamine (DTPD). Typical amounts of antiozonants, if used, may for instance comprise 1 phr to 5 phr. In some aspects, antiozonants are included in amounts of about 1 phr to 5 phr.

In one aspect, the additive is a fatty acid. Typical amounts of fatty acids, if used, which can include stearic acid in an amount of 0.5 phr to 3 phr.

In one aspect, the additive is a wax. Typical amounts of waxes, if used, may include 1 phr to 5 phr.

In one aspect, the additive is zinc oxide. Typical amounts of zinc oxide, if used, may include 1 phr to 5 phr.

In one aspect, the uncured rubber composition can further include about 0.4 phr to about 10 phr of a vulcanizing agent, or about 0.4 phr, 1 phr, 2 phr, 3 phr, 4 phr, 5 phr, 6 phr, 7 phr, 8 phr, 9 phr, or 10 phr, where any value can be a lower and upper endpoint of a range (e.g., 3 phr to 8 phr). In some aspects, the vulcanizing agent includes elemental sulfur, a sulfur-containing silane, or a combination thereof. Additionally, the uncured rubber composition can further include a vulcanizing accelerator. Vulcanizing accelerators can be preferably but not necessarily used to control the time and/or temperature required for vulcanization and to improve the properties of a vulcanized composition. The amount of vulcanizing accelerator in the composition can be in the amount of about 0.3 phr to about 4 phr, or 0.3 phr, 1 phr, 2 phr, 3 phr, or 4 phr, where any value can be a lower and upper endpoint of a range (e.g., 1 phr to 2 phr).

In some aspects, the vulcanizing accelerator includes a dithiocarbamate accelerator, a thiuram accelerator, a diphenylguanidine accelerator, a benzothiazole sulfenamide accelerator, or a combination thereof. The potential vulcanizing accelerator compounds can include derivatives, e.g., a benzothiazole sulfenamide accelerator includes benzothiazole sulfenamide and can also include derivatives of benzothiazole sulfenamide. In other aspects, the vulcanizing accelerator includes amines, disulfides, guanidines, thioureas, thiazoles, thiurams, sulfenamides, dithiocarbamates and xanthates. In another aspect, the vulcanizing accelerator includes combinations of a primary and a secondary accelerator, where the secondary accelerator is used in smaller amounts, such as from 0.05 phr to 3.00 phr. In some aspects, the secondary accelerator is selected from a guanidine, a dithiocarbamate, or a thiuram. In addition, delayed action accelerators can be used which are not affected by normal processing temperatures but produce a satisfactory cure at ordinary vulcanization temperatures.

In one aspect, the uncured rubber composition can include an oil. In some aspects, the oil is a processing oil. The processing oil can be included in the composition as an extending oil typically used to extend elastomers. The processing oil can also be included in the elastomer composition by addition of the oil directly during rubber compounding. The processing oil used can include both an extending oil present in the elastomers and a process oil added during compounding. Suitable processing oils include, but are not limited to, various oils as are known in the art, including aromatic, paraffinic, naphthenic, vegetable oils, and low PCA oils, such as MES, TDAE, SRAE, and heavy naphthenic oils. Suitable low PCA oils may include those having a polycyclic aromatic content of less than 3% by weight as determined by the IP346 method. Procedures for the IP346 method can be found in Standard Test Methods for Analysis and Testing of Petroleum and Related Products and British Standard 2000 Parts, 2003, 62nd edition, published by the Institute of Petroleum, United Kingdom. Suitable TDAE oils are available as Tudalen SX500 from Klaus Dahleke KG, VivaTec 400 and VivaTec 500 from H&R Group, Enerthene 1849 from BP, and Extensoil 1996 from Repsol. The oils can be available as the oil alone or along with an elastomer in the form of an extended elastomer. Suitable vegetable oils include, for example, soybean oil, sunflower oil, and canola oil which are in the form of esters containing a certain degree of unsaturation.

In one aspect, the rubber composition can include carbon black. Commonly employed carbon blacks can be used as a conventional filler. Representative examples of such carbon blacks include NII0, N121, N134, N220, N231, N234, 55 N242, N293, N299, 5315, N326, N330, M332, N339, N343, N347, N351, N358, N375, N539, N550, N582, N630, N642, N650, N683, N754, N762, N765, N774, N787, N907, N908, N990 and N991. These carbon blacks have iodine absorptions ranging from about 9 g/kg to about 145 g/kg and DBP numbers ranging from about 34 cm³/100 g to about 150 cm³/100 g. In one aspect, the rubber composition can include from about 20 phr to about 160 phr of carbon black.

Described herein are vulcanized rubber compositions, where any of the uncured rubber compositions described herein have been vulcanized. The vulcanized rubber compositions possess improved physical properties such as, for example, stiffness and hysteresis, while not compromising other properties (e.g., abrasion resistance and tensile strength).

In one aspect, the vulcanized rubber composition has a stiffness of about 1.70 to about 1.90 as determined by a rubber process analyzer (RPA 2000™ from Alpha Technologies, G′ at 10% sinusoidal deformation, 100° C., 1 Hz, based on ASTM D5289), or about 1.70, 1.72, 1.74, 1.76, 1.78, 1.80, 1.82, 1.84, 1.86, 1.88, or 1.90, where any value can be a lower and upper endpoint of a range (e.g., 1.72 to 1.88). In another aspect, the vulcanized rubber composition has a stiffness of about 35% to about 45% greater when compared to the same composition without the partially saturated elastomer, wherein the stiffness is determined by a rubber process analyzer (RPA 2000™ from Alpha Technologies, G′ at 10% sinusoidal deformation, 100° C., 1 Hz, based on ASTM D5289), or about 35%, 36%, 37%, 38%, 39%, 40%, 41%, 42%, 43%, 44%, or 45%, where any value can be a lower and upper endpoint of a range (e.g., 37% to 42%).

In one aspect, the vulcanized rubber composition has a hysteresis of about 0.24 to about 0.26 as determined by a dynamic mechanical analyzer (ARES, Tan Delta at 10% sinusoidal deformation, 90° C., 10 Hz, based on ASTM D5992), or about 0.24, 0.242, 0.244, 0.246, 0.248, 0.25, 0.252, 0.254, 0.256, 0.258, or 0.26, where any value can be a lower and upper endpoint of a range (e.g., 0.244 to 0.256). In another aspect, the vulcanized rubber composition has a hysteresis of about 25% to about 35% greater when compared to the same composition without the partially saturated elastomer, wherein hysteresis is determined by a dynamic mechanical analyzer (ARES, Tan Delta at 10% sinusoidal deformation, 90° C., 10 Hz, based on ASTM D5992), or about 25%, 26%, 27%, 28%, 29%, 30%, 31%, 32%, 33%, 34%, or 35%, where any value can be a lower and upper endpoint of a range (e.g., 27% to 32%).

### Preparation and Applications of Rubber Compositions

The preparation of the uncured rubber compositions described herein can be accomplished by methods generally used in the rubber mixing art. For example, the ingredients may be typically mixed in at least two stages, namely, at least one non-productive stage followed by a productive mix stage. The final curatives including sulfur-vulcanizing agents may be typically mixed in the final stage which is conventionally called the “productive” mix stage in which the mixing typically occurs at a temperature, or ultimate temperature, lower than the mix temperature(s) of the preceding non-productive mix stage(s). The terms “non-productive” and “productive” mix stages are well known to those having skill in the rubber mixing art. In one embodiment, the rubber composition may be subjected to a thermomechanical mixing step. The thermomechanical mixing step generally includes a mechanical working in a mixer or extruder for a period of time, for example suitable to produce a rubber temperature between 140° C. and 190° C. The appropriate duration of the thermomechanical working varies as a function of the operating conditions, and the volume and nature of the components. For example, the thermomechanical working may be from 1 to 20 minutes.

After the uncured rubber composition has been prepared, it is vulcanized to produce a vulcanized rubber composition. In one embodiment, vulcanization can be carried out at temperatures ranging from about 100° C. to about 200° C. or 110° C. to about 180° C. Vulcanization processes can include heating in a press or mold or heating with superheated steam or hot air. The vulcanized rubber composition can be built, shaped, or molded into any desired shape or article.

This disclosure also provides for articles that incorporate any of the vulcanized rubber compositions disclosed herein. In some aspects, the article comprises a tire, such as a pneumatic tire, or a component of a tire. The tire can be a race tire, passenger tire, aircraft tire, agricultural, earthmover, off-the-road, truck tire, or the like. In one aspect, the tire is a passenger or truck tire. The tire can also be a radial or bias. The component of the tire can be a tread, base, apex, chafer, or any combination thereof. In another aspect, the component of the tire including the composition is a tread, base, sidewall, or any combination thereof. Vulcanization of the disclosed tires is generally carried out at conventional temperatures ranging from about 100° C. to about 200° C. or from about 110° C. to about 180° C. Such tires can be built, shaped, molded and cured by various methods which are known and will be readily apparent to those having skill in such art.

Now having described the aspects of the present disclosure, in general, the following Examples describe some additional aspects of the present disclosure. While aspects of the present disclosure are described in connection with the following examples and the corresponding text and figures, there is no intent to limit aspects of the present disclosure to this description. On the contrary, the intent is to cover all alternatives, modifications, and equivalents included within the spirit and scope of the present disclosure.

### ASPECTS

The present disclosure can be described in accordance with the following numbered Aspects, which should not be confused with the claims.
Aspect 1. An uncured composition comprising:
   at least one partially saturated elastomer comprising repeat units, wherein less than or equal to 15% of all repeat units of the partially saturated elastomer comprise a double bond,
   a bismaleimide, and
   a polyoctenamer.
Aspect 2. The composition of Aspect 1, wherein the partially saturated elastomer comprises repeat units formed by residues of monomers selected from one or more of ethylene, propylene, butadiene, isoprene, styrene, and any combination thereof.
Aspect 3. The composition of Aspect 1, wherein the partially saturated elastomer is a partially hydrogenated styrene butadiene rubber.
Aspect 4. The composition of any one of Aspects 1 to 3, wherein the partially saturated elastomer has a glass transition temperature of about −20° C. to about −65° C.
Aspect 5. The composition of any one of Aspects 1 to 4, wherein the partially saturated elastomer has a weight average molecular weight of 200,000 g/mol to 500,000 g/mol.
Aspect 6. The composition of any one of Aspects 1 to 5, wherein from about 4% to about 11% of all repeat units have a double bond.
Aspect 7. The composition of any one of Aspects 1 to 6, comprising
   75 phr to 100 phr of the partially saturated elastomer, and
   0 phr to 25 phr of one or more of polybutadiene rubber, polyisoprene, hydrogenated styrene butadiene rubber, and natural rubber.
Aspect 8. The composition of any one of Aspects 1 to 7, wherein the partially saturated elastomer comprises a solution-polymerized styrene butadiene rubber having one or more of:
   i) less than 5% of nonhydrogenated vinyl groups, based on the total number of vinyl groups of the hydrogenated styrene butadiene rubber;
   ii) less than 20% of nonhydrogenated double bonds in cis-1,4 and trans-1,4 butadiene repeat units, based on the total number of cis-1,4 and trans-1,4 butadiene repeat units;
   iii) from 80% to 99% of hydrogenated double bonds; and
   iv) a bound styrene content ranging from 5% to 40% and a butadiene content ranging from 60% to 95%, by weight.
Aspect 9. The composition of any one of Aspects 1 to 8, wherein the bismaleimide comprises N,N′-m-phenylenebismaleimide.
Aspect 10. The composition of any one of Aspects 1 to 9, wherein the bismaleimide is from 1 phr to 10 phr.
Aspect 11. The composition of any one of Aspects 1 to 10, wherein the polyoctenamer is from 5 phr to 20 phr.
Aspect 12. The composition of any one of Aspects 1 to 11, wherein the composition further comprises carbon black in an amount from 25 phr to 100 phr.
Aspect 13. The composition of any one of Aspects 1 to 12, wherein the composition further comprises an oil in an amount from 10 phr to 30 phr.
Aspect 14. The composition of any one of Aspects 1 to 13, wherein the composition further comprises a vulcanizing agent in the amount of 0.4 phr to 10 phr.
Aspect 15. The composition of any one of Aspects 1 to 14, wherein the composition further comprises a vulcanizing accelerator in the amount of 0.3 phr to 4 phr.
Aspect 16. A vulcanized rubber composition comprising the uncured composition of any one of Aspects 1 to 15 that has been vulcanized.
Aspect 17. The composition of Aspect 16, wherein the composition has a stiffness of about 1.70 to about 1.90 as determined by a rubber process analyzer (RPA 2000™ from Alpha Technologies, G′ at 10% sinusoidal deformation, 100° C., 1 Hz, based on ASTM D5289) and a hysteresis of about 0.24 to about 0.26 as determined by a dynamic mechanical analyzer (ARES, Tan Delta at 10% sinusoidal deformation, 90° C., 10 Hz, based on ASTM D5992).
Aspect 18. The composition of Aspect 16 or 17, wherein the composition has a stiffness of about 35% to about 45% greater when compared to the same composition without the partially saturated elastomer, wherein the stiffness is determined by a rubber process analyzer (RPA 2000™ from Alpha Technologies, G′ at 10% sinusoidal deformation, 100° C., 1 Hz, based on ASTM D5289).
Aspect 19. The composition of any one of Aspects 16 to 18, wherein the composition has a hysteresis of about 25% to about 35% greater when compared to the same composition without the partially saturated elastomer, wherein hysteresis is determined by a dynamic mechanical analyzer (ARES, Tan Delta at 10% sinusoidal deformation, 90° C., 10 Hz, based on ASTM D5992).
Aspect 20. An article comprising the vulcanized rubber composition of any one of Aspects 16 to 19.
Aspect 21. The article of Aspect 20, wherein the article comprises a tire or a component of a tire.
Aspect 22. The article of Aspect 21, wherein the component of the tire comprises a tread, base, apex, chafer, or any combination thereof.

### Examples

The following examples are put forth so as to provide those of ordinary skill in the art with a complete disclosure and description of how the compounds, compositions, articles, devices and/or methods claimed herein are made and evaluated. These examples are intended to be purely exemplary of the disclosure and are not intended to limit the scope of what the inventors regard as their disclosure. Efforts have been made to ensure accuracy with respect to numbers (e.g., amounts, temperature, etc.), but some errors and deviations should be accounted for. Unless indicated otherwise, parts are parts by weight, temperature is in ° C. or is at ambient temperature, and pressure is at or near atmospheric.

Five elastomer compositions (C1-C4 and I1) are provided in Table 1 (amounts in phr). The most notable difference is that I1, a rubber composition as described herein, includes as the elastomer component only a partially saturated elastomer comprising repeat units, wherein less than or equal to 15% of all repeat units of the partially saturated elastomer comprise a double bond (referred to herein as “HSBR”). C1-C4 includes natural rubber and ESBR (standard emulsion-SBR rubber, 1502 type with no partial saturation of the butadiene portion) as the elastomer component with no HSBR.

Table 2 provides test results for each rubber composition. As provided in Table 2, the use of HSBR in I1 results in the formation of a vulcanized rubber composition having improved stiffness and hysteresis while maintaining abrasion resistance, tear resistance, and tensile strength relative to C1-C4. These results demonstrate that rubber compositions produced with HSBR have improved properties without compromising other properties of the rubber composition.

TABLE 1

| Ingredient | C1 | C2 | C3 | C4 | I1 |
|---|---|---|---|---|---|
| NR | 15 | 15 | 15 | 15 | |
| ESBR (PLF1502 - Goodyear Chemical) | 85 | 85 | 85 | 85 | |
| HSBR (NT120 - ENEOS) | | | | | 100 |
| CB (N220 type) | 60 | 60 | 60 | 60 | 60 |
| polyoctenamer (Vestenamer 4012 - Evonik) | | 10 | | 10 | 10 |
| naphtenic oil | | 20 | | 20 | 20 |
| mix of HC resin (Promix 400 - Flow Polymers) | 5 | 5 | 5 | 5 | 5 |
| heat-reactive HC resin (LX-782 - Neville Chemical) | 5 | 5 | 5 | 5 | 5 |
| mod. gum rosin (Resinall 224 - Resinall) | 5 | 5 | 5 | 5 | 5 |
| microcrystalline wax | 1 | 1 | 1 | 1 | 1 |
| zinc oxide | 3 | 3 | 3 | 3 | 3 |
| stearic acid | 1 | 1 | 1 | 1 | 1 |
| 6PPD | 3 | 3 | 3 | 3 | 3 |
| TESPT on CB carrier | | 2 | | 2 | 2 |
| sulfur | 0.94 | 0.94 | 0.94 | 0.94 | 0.94 |
| N,N′-m-Phenylenedimaleimide | | | 4 | 4 | 4 |
| (HVA2-PRC Chemours Co) | | | | | |
| TBBS | 1.42 | 1.42 | 1.42 | 1.42 | 1.42 |
| DPG | 1.2 | 1.2 | 1.2 | 1.2 | 1.2 |

TABLE 2

| Properties | Units | C1 | C2 | C3 | C4 | I1 |
|---|---|---|---|---|---|---|
| stiffness | | | | | | |
| RPA G′ (1%; 100° C.; 1 Hz) | MPa | 2.79 | 1.53 | 7.30 | 3.85 | 4.06 |
| RPA G′ (10%; 100° C.; 1 Hz) | MPa | 1.30 | 0.800 | 2.46 | 1.49 | 1.81 |
| RPA G′ (140% 100° C. 1 Hz) | MPa | 0.557 | 0.359 | 0.658 | 0.455 | 0.532 |
| hysteresis | | | | | | |
| RPA TD (1%; 100° C.; 1 Hz) | | 0.255 | 0.215 | 0.157 | 0.149 | 0.159 |
| RPA TD (10%; 100° C.; 1 Hz) | | 0.271 | 0.229 | 0.245 | 0.219 | 0.237 |
| RPA TD (140% 100° C. 1 Hz) | | 0.305 | 0.285 | 0.363 | 0.265 | 0.275 |
| ARES TD (10%, 90° C., 1Hz) | | 0.352 | 0.312 | 0.307 | 0.281 | 0.251 |
| ZWICK REBOUND VALUE at 100° C. | % | 38.2 | 42.9 | 43.3 | 44.2 | 50.3 |
| (ASTM 1054) | | | | | | |
| abrasion | | | | | | |
| GROSCH ABRASION (LAT-100) VOLUME | mg/km | 432 | 946 | 692 | 1026 | 454 |
| LOSS | | | | | | |
| tear | | | | | | |
| STREBLER TEAR FORCE (DIN 53539) | N | 183 | 59.8 | 175 | 190 | 192 |
| INSTRON TEAR STRENGTH (DIN 53539) | N/mm | 75.9 | 59.6 | 55.2 | 52.0 | 66.1 |
| tensile | | | | | | |
| INSTRON DIE C 10% MODULUS (ASTM | MPa | 0.90 | 0.66 | 1.29 | 0.85 | 1.06 |
| D412) | | | | | | |
| INSTRON DIE C 100% MODULUS (ASTM | MPa | 2.10 | 1.53 | 3.16 | 2.10 | 2.31 |
| D412) | | | | | | |
| INSTRON DIE C 300% MODULUS (ASTM | MPa | 7.40 | 4.10 | 10.1 | 5.59 | 6.98 |
| D412) | | | | | | |
| INSTRON DIE C TENSILE STRENGTH | MPa | 20.0 | 14.9 | 19.5 | 15.0 | 20.3 |
| (ASTM D412) | | | | | | |

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

1. An uncured composition comprising:
at least one partially saturated elastomer comprising repeat units, wherein less than or equal to 15% of all repeat units of the partially saturated elastomer comprise a double bond,
a bismaleimide, and
a polyoctenamer.

2. The composition of claim 1, wherein the partially saturated elastomer comprises repeat units formed by residues of monomers selected from one or more of ethylene, propylene, butadiene, isoprene, styrene, and any combination thereof.

3. The composition of claim 1, wherein the partially saturated elastomer is a partially hydrogenated styrene butadiene rubber.

4. The composition of claim 1, wherein the partially saturated elastomer has a glass transition temperature of about −20° C. to about −65° C.

5. The composition of claim 1, wherein the partially saturated elastomer has a weight average molecular weight of 200,000 g/mol to 500,000 g/mol.

6. The composition of claim 1, wherein from about 4% to about 11% of all repeat units have a double bond.

7. The composition of claim 1, comprising
75 phr to 100 phr of the partially saturated elastomer, and
0 phr to 25 phr of one or more of polybutadiene rubber, polyisoprene, hydrogenated styrene butadiene rubber, and natural rubber.

8. The composition of claim 1, wherein the partially saturated elastomer comprises a solution-polymerized styrene butadiene rubber having one or more of:
i) less than 5% of nonhydrogenated vinyl groups, based on the total number of vinyl groups of the hydrogenated styrene butadiene rubber;
ii) less than 20% of nonhydrogenated double bonds in cis-1,4 and trans-1,4 butadiene repeat units, based on the total number of cis-1,4 and trans-1,4 butadiene repeat units;
iii) from 80% to 99% of hydrogenated double bonds; and
iv) a bound styrene content ranging from 5% to 40% and a butadiene content ranging from 60% to 95%, by weight.

9. The composition of claim 1, wherein the bismaleimide comprises N,N′-m-phenylenebismaleimide.

10. The composition of claim 1, wherein the bismaleimide is from 1 phr to 10 phr.

11. The composition of claim 1, wherein the polyoctenamer is from 5 phr to 20 phr.

12. The composition of claim 1, wherein the composition further comprises carbon black in an amount from 25 phr to 100 phr.

13. The composition of claim 1, wherein the composition further comprises an oil in an amount from 10 phr to 30 phr.

14. The composition of claim 1, wherein the composition further comprises a vulcanizing agent in the amount of 0.4 phr to 10 phr and a vulcanizing accelerator in the amount of 0.3 phr to 4 phr.

15. A vulcanized rubber composition comprising the uncured composition of claim 1 that has been vulcanized.

16. The composition of claim 15, wherein the composition has a stiffness of about 1.70 to about 1.90 as determined by a rubber process analyzer (G′ at 10% sinusoidal deformation, 100° C., 1 Hz, based on ASTM D5289) and hysteresis of about 0.24 to about 0.26 as determined by a dynamic mechanical analyzer (Tan Delta at 10% sinusoidal deformation, 90° C., 10 Hz, based on ASTM D5992).

17. The composition of claim 15, wherein the composition has a stiffness of about 35% to about 45% greater when compared to the same composition without the partially saturated elastomer, wherein the stiffness is determined by a rubber process analyzer (G′ at 10% sinusoidal deformation, 100° C., 1 Hz, based on ASTM D5289), and the composition has a hysteresis of about 25% to about 35% greater when compared to the same composition without the partially saturated elastomer, wherein hysteresis is determined by a dynamic mechanical analyzer (Tan Delta at 10% sinusoidal deformation, 90° C., 10 Hz, based on ASTM D5992).

18. An article comprising the vulcanized rubber composition of claim 15.

19. The article of claim 18, wherein the article comprises a tire or a component of a tire.

20. The article of claim 19, wherein the component of the tire comprises a tread, base, apex, chafer, or any combination thereof.
